(19) United States
(12) Patent Application Publication
(10) Pub. No.: US 2024/0049128 A1
(43) Pub. Date: Feb. 8, 2024

(54) FIRST NETWORK NODE AND METHOD IN A COMMUNICATION NETWORK FOR CONTROLLING POWER CONSUMPTION

(71) Applicant: Telefonaktiebolaget LM Ericsson (PUBL), Stockholm (SE)

(72) Inventors: Reiner Ludwig, HÜRTGENWALD (DE); Pål Frenger, LINKÖPING (SE); Jonas Bengtsson, HÄLJARP (SE)

(21) Appl. No.: 18/258,952

(22) PCT Filed: Dec. 30, 2020
(86) PCT No.: PCT/SE2020/051266

§ 371 Date: Jun. 22, 2023

(51) Int. Cl. H04W 52/02; H04W 28/02

(52) U.S. Cl. CPC H04W 52/0206; H04W 28/0221; H04W 28/0231

(57) ABSTRACT

A method performed by a first network node for controlling power consumption in a second network node in a wireless communications network is provided. The second network node is operating in a first power consumption level out of multiple power consumption levels. The first network node 111 obtains (501) one or more performance parameters related to data traffic performance of User Equipment (UE) connections served by the second network node during a time interval. The first network node 111 determines (502) a proportion of the UE connections that are associated with a performance parameter exceeding a first threshold. The determination is based on the obtained one or more performance parameters. The first network node 111 decides (503) whether or not to switch from the first power consumption level to a second power consumption level out of the multiple power consumption levels. The decision is based on the determined proportion of UE connections that are associated with a performance parameter exceeding the first threshold.

### TECHNICAL FIELD

Embodiments herein relate to a first network node and a method therein. In some aspects, they relate to controlling power consumption in a second network node in a wireless communications network.

### BACKGROUND

In a typical wireless communication network, wireless devices, also known as wireless communication devices, mobile stations, stations (STA) and/or User Equipments (UE), communicate via a Local Area Network such as a W-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a W-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

Today's mobile networks, also referred to as wireless communications networks, have a large potential for energy savings. Within 3GPP and other organizations there has been an increasing focus on reducing energy consumption for base stations.

There are several RAN energy saving features in products that may be applied when and where the traffic is low. Some examples, relating to Omni transmission, MIMO sleep mode, Small cell sleep mode and booster carrier sleep mode, are depicted in FIG. 1. Typically, these features are activated only during low traffic hours and in certain regions, i.e. when and where the traffic is expected to be low.

When deciding when to trigger activation of energy saving features, such as e.g. omni-transmission, MIMO sleep mode, small cell sleep mode, booster carrier sleep mode, deactivation of dual connectivity or carrier aggregation, etc, the State-Of-The Art (SOTA) is to look at Physical Resource Blocks (PRB) utilization as well as the number of currently active UEs.

Using only PRB utilization is not efficient since a single UE with a large download can easily trigger a cell to unnecessary leave the energy saving mode. But even if PRB utilization is combined with information related to the number of active UEs there are situations where SOTA triggering methods for energy saving activation will fail.

FIG. 2 exemplifies a problem scenario with both high PRB utilization as well as a high number of active UEs. In case the base station is equipped with a massive MIMO antenna array capable of multi-user MIMO, and spatial separation of user transmissions and receptions, then it may well be the case that all UEs have good performance and are happy with the service quality they receive.

Still, when using SOTA methods, it would result in leaving the energy saving mode, also referred to as low energy consumption mode, wherein e.g. only one carrier providing service to the active UEs, and enter a full or increased capacity mode with more capacity in the cell provided by the base station, e.g. by activate of a second carrier. This is a problem since activating more capacity in this case would cause unnecessary increase of the base station energy consumption.

There may further be a situation where the PRB utilization is high and the number of connected UEs is low, as depicted in FIG. 3. FIG. 3 exemplifies a problem scenario with SOTA wherein even a small number of users can experience poor performance e.g. due to poor link budget, low bandwidth, low spatial separation.

Using SOTA methods to determine if we should leave a low energy consumption mode and enter a full or increased capacity mode the low number of connected users would be considered, and it would be determine that while the PRB utilization is high there is still no need to add extra capacity to this cell. However, the UEs may still experience poor performance caused by e.g.
Low signal strength (more RBS power would help)
Low bandwidth (activating second carrier would help)
Little spatial separation (activation of more MIMO antennas would help), etc.

To not activate more capacity in this example is a problem since this will cause unnecessary poor user experience for the users that are connected.

### SUMMARY

An object of embodiments herein is to improve UE experience in a communications network using power consumption control for saving energy.

According to an aspect of embodiments herein, the object is achieved by a method performed by a first network node for controlling power consumption in a second network node in a wireless communications network. The second network node is operating in a first power consumption level out of multiple power consumption levels. The first network node obtains one or more performance parameters related to data traffic performance of User Equipment, UE, connections served by the second network node during a time interval. The first network node determines a proportion of the UE connections that are associated with a performance parameter exceeding a first threshold, based on the obtained one or more performance parameters. The first network node decides whether or not to switch from the first power consumption level to a second power consumption level out of the multiple power consumption levels. The deciding is based on the determined proportion of UE connections that are associated with a performance parameter exceeding the first threshold.

According to an aspect of embodiments herein, the object is achieved by a first network node configured to control power consumption in a second network node in a wireless communications network. The second network node is adapted to operate in a first power consumption level out of multiple power consumption levels. The first network node further is configured to:
Obtain one or more performance parameters adapted to be related to data traffic performance of User Equipment, UE, connections served by the second network node during a time interval,
determine a proportion of the UE connections that are adapted to be associated with a performance parameter exceeding a first threshold based on the obtained one or more performance parameters, and
decide whether or not to switch from the first power consumption level to a second power consumption level out of the multiple power consumption levels based on the determined proportion of UE connections that are associated with a performance parameter exceeding the first threshold.

Since the decision of whether or not to switch from a first power consumption level to a second power consumption level is based on the proportion of UE connections that are associated with a performance parameter exceeding the first threshold, it is possible to use a lower power consumption level when the UE experience is not negatively affected. This results in an improved UE experience in a communications network using power consumption control for saving energy. This is since the lower power consumption level will not be used when UE experience is negatively affected.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating prior art.

FIG. 3 is a schematic block diagram illustrating prior art.

FIG. 4 is a schematic block diagram illustrating embodiments of a communications network.

FIG. 5 is a flowchart depicting embodiments of a method in a first network node.

FIG. 6 is a diagram depicting embodiments herein.

FIGS. 7 a-b are diagrams depicting embodiments herein.

FIG. 8 depicts diagrams of embodiments herein.

FIG. 9 is a schematic flowchart depicting embodiments of a method.

FIGS. 10 a-b are schematic block diagrams illustrating embodiments of a first network node.

FIG. 11 schematically illustrates a telecommunication network connected via an intermediate network to a host computer.

FIG. 12 is a generalized block diagram of a host computer communicating via a base station with a user equipment over a partially wireless connection.

FIGS. 13-16 are flowcharts illustrating methods implemented in a communication system including a host computer, a base station and a user equipment.

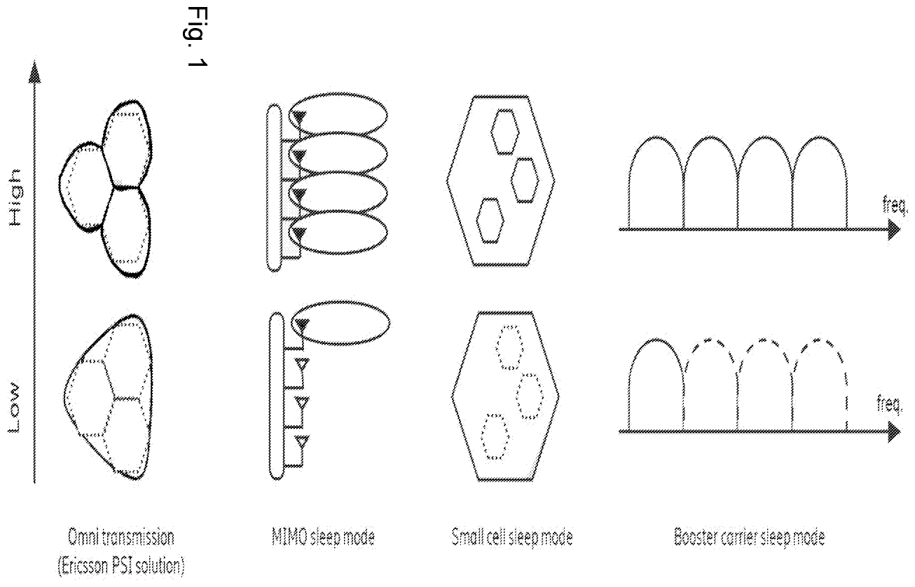

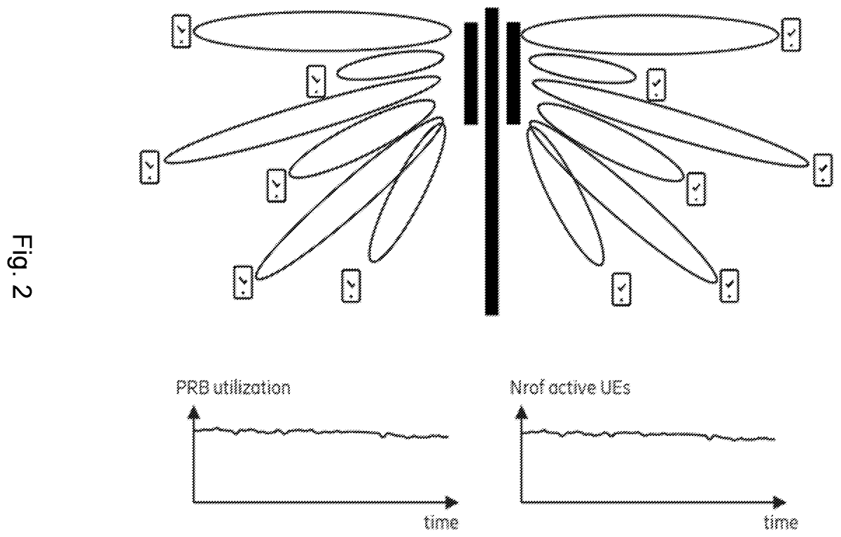

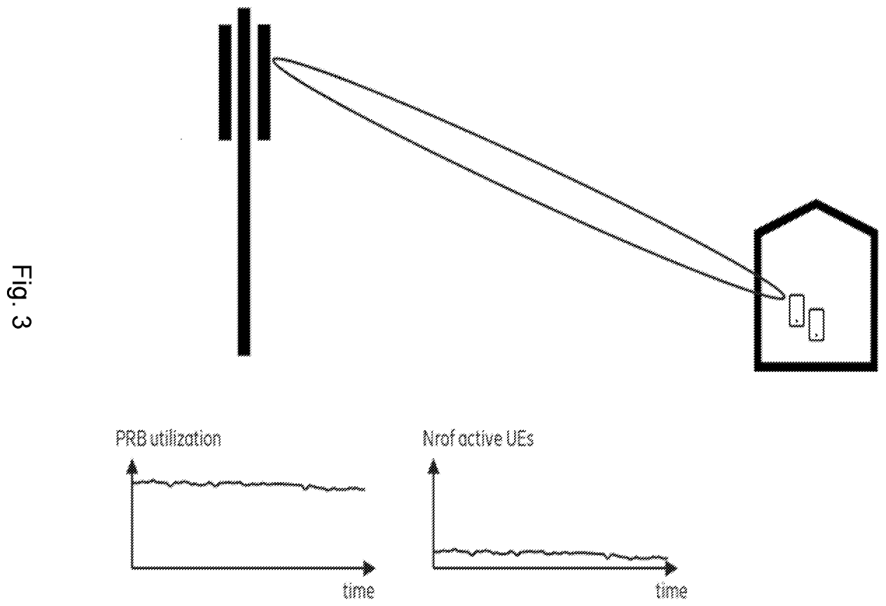

### DETAILED DESCRIPTION

Embodiments herein relates to handling such as controlling power consumption a network node, e.g. by using user-experience based triggering of network energy saving features. User-experience means the service performance experienced by a user of a UE.

It should be noted that the user may be a machine, e.g. in a case where the UE relates to a so-called machine-to-machine use cases.

According to some example embodiments herein, the decision to activate or deactivate RAN energy saving features is based on a high percentile value of the UE throughput. With “high percentile” it is here refered to that a high ratio of the UEs have a good enough throughput (e.g. above a threshold). Note that this is equivalent to saying that a low ratio of UEs have a bad throughput (e.g. below a threshold). Sometimes the term “cell-edge performance” is used to describe e.g. the 10^{th} or 5^{th} percentile of the user throughput distribution. For consistency, we only refer to the percentile of UEs with good enough performance in this description, and consequently we will describe the same thing as a 90^{th} or 95^{th} percentile value. A high percentile value is well above the median value (50%) e.g. typically in the range 80-99%.

According an example embodiment herein it is provided, a method performed by a first network node, such as a radio base station, for handling such as controlling, power consumption in a second network node, to reduce energy consumption when it is possible without decreasing user-experience. The method may be characterized by:

The first network node observes user-experience related performance indicator of several user data transmissions in a time interval and obtains a percentile value of the user data throughput based on said observations.

If said percentile value is above a threshold, the first network node configures the second network node for a low power consumption mode, and

if said percentile value is above a threshold, the first network node configures the second network node for a high capacity mode.

An object of some embodiments herein is to enable an operator of the RAN to control the energy consumed by the RAN based on a statistical minimum UE performance provided to the UEs that are served by the RAN. The mentioned statistical minimum UE performance may be defined via a ‘first threshold’ mentioned below, based on the operator's policy. Note that different operators may have different policies to tradeoff energy consumption versus a minimum performance provided to the UEs. Furthermore, note the same operator may want to apply different policies in different parts of the operator's RAN.

Embodiments herein e.g. provide the following advantages.

In some of the embodiments herein provide a triggering of energy saving features such as e.g. RAN energy saving features only when UE experience of UE connections is not negatively affected in any significant way. UE experience when used herein may mean a user experience experienced by a user that uses the UE for connections in a wireless communications network. This will be explained more in detail below.

It should be understood that it is simply not possible to reduce power consumption without negatively affecting the UE experience. It is a trade-off: More power consumption typically leads to higher/better “UE experience”, and vice versa. According to embodiments herein, the operator is enabled to control this tradeoff.

Embodiments herein provide that full capacity operation is activated before the UE experience and degradation of performance such as e.g. of Mobile Broadband (MBB) performance. This results in reduced network energy consumption while ensuring a consistently good UE experience, such as MBB UE experience throughout the day and throughout different regions in a wireless communications network.

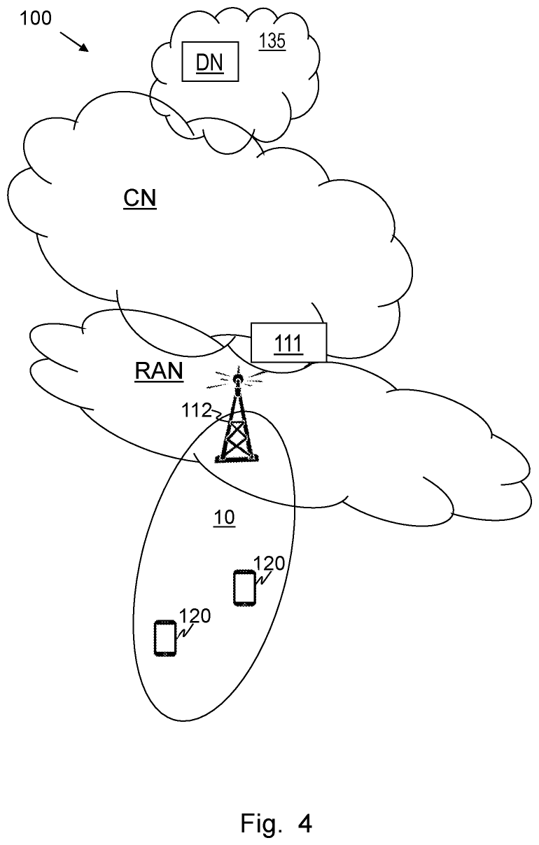

FIG. 4 is a schematic overview depicting a wireless communications network 100 wherein embodiments herein may be implemented. The wireless communications network 100 comprises one or more RANs and one or more CNs. The wireless communications network 100 may use a number of different technologies, such as W-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g. a first network node 111 and a second network node 112. The first network node 111 is associated with the network node 112. This means that the first network node 111 is capable of controlling power consumption of the second network node 112. In some embodiments the first network node 111 is at a separate location from the second network node 112, and in some embodiments the first network node 111 and the second network node 112 are co-located. The first network node 111 may e.g. be located in the RAN, in the CN or in any other place in the network or associated with the wireless communications network 100, such as e.g. in a function node in a cloud associated with or operating for the wireless communications network 100.

The second network node 112 may be a base station providing radio coverage in a number of cells which may also be referred to as a sector, or a beam or a beam group of beams, such as a cell 10 provided by the second network node 112 by means of radio equipment such as radio units and/or antenna units, which are co-located at or located at remoteness of the second network node 112.

The second network node 112 may e.g. be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a UE within the service area served by the second network node 112 depending e.g. on the first radio access technology and terminology used. The second network node 112 may be referred to as a serving network node for UEs 120 and communicates with the UEs 120 with Downlink (DL) transmissions to the respective UEs 120 and from the respective UEs and Uplink (UL) transmissions from the UEs 120.

One or more UEs operate in the communication network 100, such as e.g. the UEs 120. The UEs may also referred to as devices, IoT devices, mobile stations, non-access points (non-AP) STAs, STAs, user equipments and/or a wireless terminals, communicating via one or more Access Networks (AN), e.g. the RAN, to one or more CNs. It should be understood by the skilled in the art that “wireless device” is a non-limiting term which means any terminal, wireless communication terminal, user equipment, Machine Type Communication (MTC) device, Device to Device (D2D) terminal, a radio device in a vehicle, or node e.g. smart phone, laptop, mobile phone, sensor, relay, mobile tablets or even a small base station communicating within a cell.

Methods herein may be performed by the first network node 111. As an alternative, as also has been hinted above, a Distributed Node (DN) and functionality, e.g. comprised in a cloud 135 as shown in FIG. 4, may be used for performing or partly performing the methods herein.

A number of embodiments will now be described, some of which may be seen as alternatives, while some may be used in combination.

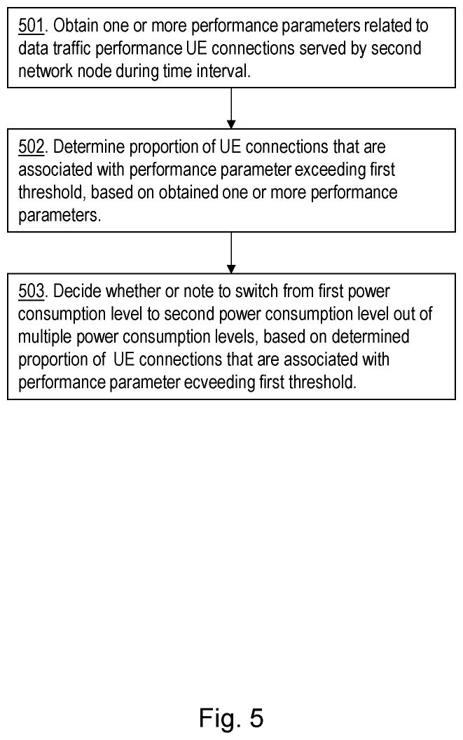

FIG. 5 shows example embodiments of a method performed by a first network node 111 for controlling power consumption in a second network node 112 in a wireless communications network 100. The second network node 112 is operating in a first power consumption level out of multiple power consumption levels. This means that the second network node 112 capable of operating in multiple power consumption levels consuming more power or less power. E.g. one or more low power consumption levels in some embodiments also including power off the second network node 112 and/or one or more high power consumption levels.

In some embodiments, the first network node 111 and the second network node 112 are co-located.

The method comprises any one or more out of the actions below, which actions may be taken in any suitable order. Actions that are optional are presented in dashed boxes in FIG. 5.

Action 501

According to a starting point of an example scenario, the second network node 112 is operating in a first power consumption level out of the multiple power consumption levels. The first power consumption level may e.g. be any of a high or a low power consumption level.

The first network node 111 obtains one or more performance parameters related to data traffic performance of UE connections served by the second network node 112 during a time interval. The one or more performance parameters will be used for estimating the proportion of the UE connections that are experienced in the UEs 120 as satisfied or as an alternative as unsatisfied, i.e. exceed a fist threshold. This in turn will be used by the first network node 111 as a basis for determining a suitable power consumption level for the second network node 112.

In some embodiments, the one or more performance parameters are aggregated in any one or more out of: A cell, a frequency band, sector of a cell, a network node site, a cluster of network node sites, a region, a geographical area. This means that the user experience on a smaller aggregation level may be allowed to be below a required threshold value if the user experience level on a higher aggregation level is above the same required threshold level. An advantage with this is that this may e.g. allow for pooling gains in some deployments such as C-RAN where a shared pool of base band processing resources is utilized by many cells. It allows for some of the processing resources, e.g. processing cores, ASICs, accelerators, etc., to be deactivated in a centralized processing node in order to reduce power consumption as long as the aggregated user experience in all served cells served by the shared processing node is above the required threshold. It may also allow for processing resources within a base station that is shared between multiple cells or beams to be put in power saving state even if this means that on some low aggregation level the user experience performance requirement is not fulfilled. Using a higher aggregation level, e.g. a geographical region or a group of cells, allows for larger power savings in the network, e.g. due to the pooling gain of shared resources. It also simplifies the action of obtaining the distribution of the user experience, a less granular statistic on a high aggregation level is faster to obtain since more sample observations of user experience may be collected in a short time duration.

A UE connection may e.g. be a connection between one of the UEs 120, and an end user such as server, via the second network node 112. Each UE 120 may have one or more UE connections at the same time, e.g. for streaming data, video, downloading web pages etc.

A performance parameter related to data traffic performance of a UE connection may e.g. be a parameter related to throughput per UE connection, or e.g. a parameter related to a measure of Time To Content (TTC). TTC may be defined from the time a link displayed in the UEs 120 is activated, also referred to as clicked on until the web page is fully downloaded and visible on the display of the UE 120. For video streaming the TTC may be defined from the time a link displayed in the UE 120 is activated, also referred to as clicked on, until the video starts playing. A good MBB UE experience may be defined as a TTC less than 2-3 seconds. A higher TTC than that quickly results in UE 120 user frustration with a requested service. Lowering the TTC to well below 1 second does not significantly improve the perceived user experience.

The obtained one or more performance parameters related to data traffic performance of UE connections during a time interval e.g. means that the UE connections are monitored during the time interval, and the performance during this time interval is then evaluated to an estimate of the performance, presented as one or more performance parameters.

In some embodiments, the one or more performance parameters are obtained by estimating the one or more performance parameters. This may be performed by e.g. measuring one or more data packet transmission rate for one or more UEs 120 and using these measurements to calculate an estimated corresponding time-to-content (TTC) value for these one or more UEs 120.

In some alternative embodiments, the one or more performance parameters are obtained by receiving the one or more performance parameters from any one out of: The second network node 112, another network node operating in the wireless communications network 100, a function operating in the wireless communications network 100, or UEs 120 in the UE connections.

This means in some embodiments that the one or more performance parameters may be obtained by receiving them from the second network node 112. In these embodiments, the second network node 112 may have estimated the one or more performance parameters.

In some other embodiments the one or more performance parameters may be obtained by receiving them from another network node operating in the wireless communications network 100. This may be in a case where the other network node is a base station comprising a distributed unit (DU) and a centralized unit (CU). In this case the DU may obtain the one or more performance parameters from the CU, and with this obtained information the DU may decide what energy saving state it needs to operate in. In other deployments a radio base station may obtain the one or more performance parameters from an Operation and Support System (OSS) node.

In some other embodiments the one or more performance parameters may be obtained by receiving them from a function operating in the wireless communications network 100. This may be in a case where a function implemented in the cloud 135 is monitoring the user experience in the radio access network and provides the one or more performance parameters to radio and base band processing units in the radio access network.

In some other embodiments the one or more performance parameters may be obtained by receiving them from UEs 120 in the UE. In these embodiments, the UEs 120 may have estimated the one or more performance parameters.

Action 502

The first network node 111 determines a proportion of the UE connections that are associated with a performance parameter exceeding a first threshold. The determination is based on the obtained one or more performance parameters. This may be performed by the same node that monitors and determines the user experience, e.g. by extracting a high percentile user performance value from the monitored distribution of user performance values) or by some other node in the radio access network.

The first threshold, also referred to as a first threshold value, may for example be a user data packet bit rate value that is expected to result in a certain required TTC value, e.g. 10 Mbit/s. The first threshold may be decided by the first network node 111 or any other network node such as e.g. an OSS node, in a network configuration file, by an algorithm running in the cloud, etc. It may be manually configured or automatically configured. The value of the first threshold may be different for different parts of the network, e.g. rural/urban, and/or for different time of day (peak traffic hour/non-peak traffic hour). The value of the first threshold may also slowly increase with time, e.g. increased every year or every quarter, as the network performance expectancy is not constant over long time periods.

As hinted above, the one or more performance parameters will be used for estimating a proportion of the UE connections that are experienced in the UEs 120 as satisfied or as an alternative as unsatisfied, i.e. exceed a fist threshold. This in turn will be used by the first network node 111 later on as a basis for determining a suitable power consumption level.

It should be noted that exceeding the first threshold may comprise the alternative that a proportion value that is less than the first threshold, or the alternative that a proportion value that is more than the first threshold. This, the determining of the value of the first threshold, and whether or not a proportion value equal to the first threshold shall be interpreted as exceeding the first threshold, may be defined in by the first network node 111 or in any other network node that have access to the statistical distribution of user performance observations. It may depend on if the data that is provided from the first network node 111 is a “full distribution”, e.g. a histogram of all observed user performance values, or the data provided is only the value of the high, e.g. 90^{th} percentile.

Action 503

As hinted above, the proportion of the UE connections that are experienced in the UEs 120 as satisfied or as an alternative as unsatisfied, i.e. exceed a fist threshold. will be used by the first network node 111 as a basis for determining a suitable power consumption level for the second network node 112.

The first network node 111 then decides whether or not to switch from the first power consumption level to a second power consumption level out of the multiple power consumption levels. According to embodiments herein, the decision is based on the determined proportion of UE connections that are associated with a performance parameter exceeding the first threshold. An advantage with this is that this correctly reflects the trade-off between network power consumption and user performance in the network. Operating in a state with high energy consumption that does not improve the user experience is wasteful. The risk of operating in a state with low energy consumption but with poor user experience can be avoided.

As hinted above, the first power consumption level may be seen as a starting point for the second network node 112, from which starting point the first network node 111 will decide whether or not to switch to another power consumption level, i.e. the second power consumption level.

In some embodiments, the multiple power consumption levels comprise at least the following, i.e. other power consumption levels may also be comprised in the multiple power consumption levels: A low power consumption level wherein the second network node 112 consumes power below a second threshold, and a high power consumption level wherein the second network node 112 consumes power above a third threshold.

The second threshold, also referred to as a second threshold value, is only used to define what is meant by a low power consumption

The third threshold, also referred to as a third threshold value, is only used to define what is meant by a high power consumption.

In an example scenario of these embodiments, the first power consumption level, may be represented by the low power consumption level. This e.g. means the second network node 112 uses low power consumption level as a starting point, and the question is whether to switch to another power consumption level, such as e.g. a higher power consumption level, or an even lower power consumption level, e.g. turning off the power. In some embodiments, the second power consumption level of the multiple power consumption levels comprise zero power consumption.

In one specific example scenario of these embodiments, the deciding whether or not to switch may comprise: Deciding to switch from the low power consumption level to the high power consumption level, when the determined proportion of UE connections that are associated with a performance parameter exceeding the first threshold, is exceeding a fourth threshold. This means that it is decided to switch from the low power consumption level to the high power consumption level, when determined proportion of UE connections exceeds the fourth threshold.

The fourth threshold, also referred to as a fourth threshold value, may for example be used to switch up from a low energy/performance state to a high energy/performance state. This fourth threshold may be determined manually per node, or by setting a policy, e.g. per region, base station type, etc, or by an automated function in wireless communications network 100.

In another example scenario of these embodiments, the first power consumption level is represented by the high power consumption level. This e.g. means the second network node 1122 uses high power consumption level as a starting point, and the question is whether to switch to another power consumption level, such as e.g. a lower energy saving power consumption level, or an even higher power consumption level.

In one specific example scenario of these embodiments, deciding whether or not to switch may comprise: Deciding to switch from the high power consumption level to the low power consumption level, when the determined proportion of UE connections that are associated with a performance parameter exceeding the first threshold, is exceeding a fifth threshold.

This means that it is decided to switch from the high power consumption level to the low power consumption level, when determined proportion of UE connections exceeds the fifth threshold.

The fifth threshold, also referred to as a fifth threshold value, may be decided by the first network node 111 or any other network node such as e.g. be determined manually per node, or by setting a policy, e.g. per region, base station type, etc., or by an automated function in the wireless communications network 100.

In some embodiments, the low power consumption level comprises to activate in the second network node 112, any one out of: a cell-sleep, a MIMO sleep, a Massive MIMO sleep, or a booster carrier sleep. Wherein:

A cell-sleep may mean that a cell in the wireless communications network 100 is deactivated, in which case it is no longer visible to the UEs, or blocked (in which case the UE 120 may still see the cell but they are not allowed to attach to it).

A MIMO sleep may mean that some of the multi-antenna processing hardware is deactivated. This may be performed by not transmitting, e.g. muting, some reference signals associated with certain physical antenna elements. Or some reference signals that would normally be transmitted from different physical antennas may be combined (merged) and transmitted from only a subset (e.g. one) of the physical antenna elements.

A Massive MIMO sleep may mean that a section or a sub-panel of a massive MIMO antenna is deactivated. This may typically result in reduced spatial separation of UE signals and/or reduced antenna gain.

A booster carrier sleep may mean that a base station such as e.g. the second network node 112 with multiple cells operating on different frequency bands may deactivate cell responsible for providing additional capacity while ensuring that another cell responsible for providing basic coverage is kept operating.

In some embodiments, the first, fourth, or fifth thresholds depend on any one out of: The time of day, or the region of the UE connections. This may be used to set policies for network power consumption and user performance trade-offs. An advantage with this is that an operator may configure the wireless communications network 100 to have higher performance in regions that are more competitive or that contain especially valuable customers, while ensuring low energy consumption and cost-efficient operation in other parts of the network.

Embodiments herein such as mentioned above will now be further described and exemplified. The text below is applicable to and may be combined with any suitable embodiment described above.

Monitoring and Evaluating UE Experience

“MBB UE user experience is king” has been embraced by many mobile operators around the world. A key factor that may limit MBB UE user experience is the lack of enough radio capacity.

This section relates to an example of how UE experience such as e.g. MBB UE user experience, may be monitored, and how parts of the wireless communications network 100, such as UE connections in the second network node 112, may be identified that e.g. delivers unnecessary high radio capacity. In these parts of the wireless communications network 100, RAN energy saving features as mentioned above in the background section above, may be utilized to lower energy consumption in the wireless communications network 100, such as the second network node 112, without any significant negative impact on the perceived UE experience.

As mentioned above, TTC may be defined from the time a link displayed in the UEs 120 is activated, also referred to as clicked on until the web page is fully downloaded and visible on the display of the UE 120. For video streaming the TTC may be defined from the time a link displayed in the UE 120 is activated, also referred to as clicked on, until the video starts playing. A good MBB UE experience may be defined as a TTC less than 2-3 seconds. A higher TTC than that quickly results in UE 120 user frustration with a requested service. Lowering the TTC to well below 1 second does not significantly improve the perceived UE user experience.

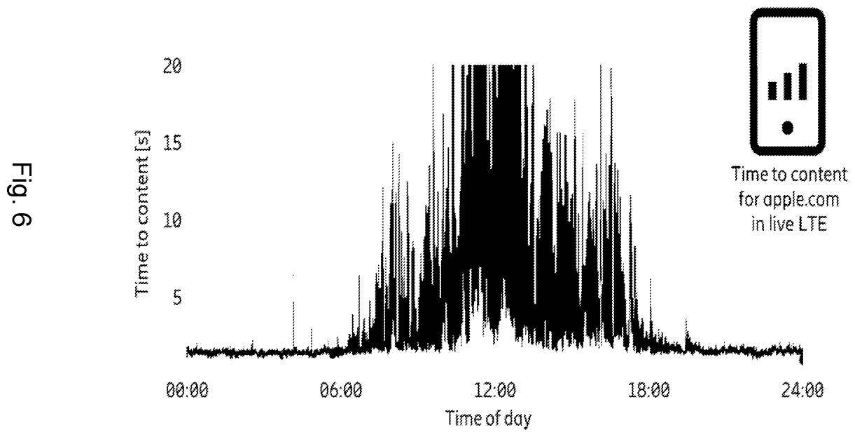

In a highly loaded cell, the TTC may vary significantly during a day, as depicted in FIG. 6. FIG. 6 shows measured TTC values for the apple.com webpage in a live network, such as e.g. the wireless communications network 100. During night hours the TTC consistently stays below 3 seconds which indicated that the user experience is good. At high traffic hours during the day some users have a terrible user experience with a TTC well above 20 seconds.

It is desirable to have a UE experience comprising a good service consistently regardless the time of day. As can be seen from FIG. 6, That is not always the case. The cell in this scenario is overloaded during a time in the middle of the day and needs more capacity during this time.

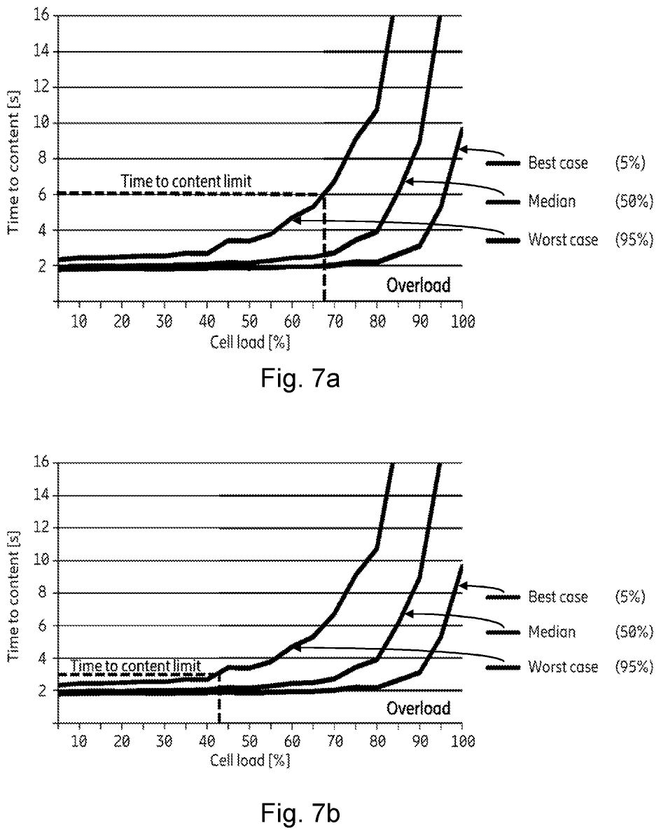

The performance in the wireless communications network 100, such as for the UE connections in the second network node 112, may stay relatively flat for a large range of cell load, from low load to medium load. As the cell load continue to increase from medium to high the user experience quickly degrades, and it may typically be observed a effect referred to as a knee effect. See FIG. 7a depicting a knee effect in a live LTE network, and FIG. 7b. depicting a knee effect in a live LTE network and a requirement on a worst case TTC that may be used to define if a cell is overloaded or not, i.e. to determine whether or not the proportion of the UE connections that are associated with a performance parameter that is exceeding the first threshold.

E.g., for users of the UEs 120 to be happy it is desirable that the UE experience is consistently good. Therefore, it is an advantage to look at a worst-case performance when determining if a cell is overloaded or not.

If according to an example in FIG. 7a, it is only acceptable that a UE experience that is a TTC longer than 6 seconds one time out of twenty, i.e. 95% of the time the TTC is below 6 seconds, it may be defined the system as being overloaded when the cell load is above 67%. This relates to Action 502 described above, for determining a proportion of the UE connections, in this example referred to as a proportion of the cell load of the cell 10 provided by the second network node 112, that are associated with a performance parameter, in this example a TTC, exceeding a first threshold, in this example 67%, based on the obtained one or more performance parameters, in this example TTCs. Further, the first network node 111 may then decide as mentioned in Action 503 mentioned above, whether or not to switch from the first power consumption level to a second power consumption level out of the multiple power consumption levels based on the determined proportion of UE connections that are associated with a performance parameter exceeding the first threshold.

Thus, e.g. if the cell load is exceeded by being above 67%, the cell 10 is overloaded and if the second network node 111 uses a first power consumption level that is normal power consumption or high power consumption, it is an advantage to decide to not to switch to a second power consumption level that is a low power consumption level, rather to switch to another second power consumption level that is even higher than the first power consumption level.

Thus, e.g. if the cell load is below 67%, the cell 10 is not overloaded and if the second network node 111 uses a first power consumption level that is normal power consumption or high power consumption, it is an advantage to decide to switch to a second power consumption level that is a low power consumption level.

If it according to an example in FIG. 7b, se similar explanations as above in FIG. 7a but using other values, it is required a UE experience that is a TTC less than 3 seconds for 95% of the time, it may be defined the system as being overloaded much earlier i.e. when the cell load is around 42%.

Thus, e.g. if the cell load is exceeded by being above 42%, the cell 10 is overloaded and if the second network node 111 uses a first power consumption level that is normal power consumption or high power consumption, it is an advantage to decide to not to switch to a second power consumption level that is a low power consumption level, rather to switch to a second power consumption level that is even higher than the first power consumption level.

Further, e.g. if the cell load is below 42%, the cell 10 is not overloaded and if the second network node 111 uses a first power consumption level that is normal power consumption or high power consumption, it is an advantage to decide to switch to a second power consumption level that is a low power consumption level.

Some embodiments are e.g. performed based on a statistical minimum UE performance. With UE performance it is typically meant throughput per UE connection, e.g., per RRC connection, but that's only one example. Other performance metrics per UE connection may apply instead or in addition. The term ‘statistical’ may be used instead of the term ‘average’. One example of ‘statistical minimum UE performance’ is the 90^{th} percentile, one example of the ‘first threshold’ mentioned herein of throughput per UE connection measured across all UE connections associated with a certain geographical area, e.g., a sector of an antenna site, and a certain time period.

The higher the load, the more inconsistent the UE experience becomes. A consequence of this is that any type of averages measurements, such as e.g. mean UE throughput, are misleading. To ensure a good UE experience it is advisable to stay “left of the knee” with some margin. Increasing the data resources, e.g. by adding more capacity in the network, moves the knee to the right. Decreasing the data resources, e.g. by deactivating capacity in cells in order to reduce the second network node 112 power consumption, moves the knee to the left. See again FIGS. 7a and b.

The TTC may typically be determined by the time it takes to receive the first 2 MB of data, which is a typical size of a large web page or the typical size a streaming video service need to download to the UE 120 before the video start playing.

2 MB may be the maximum number of bytes that can be transferred in DL with a bit-rate of 5 Mbps, while still meeting time to content limit of 3 seconds wherein:

5 M bps×3 s≅2 Mbyte

FIG. 8 depicts a set of live network measurements for an LTE cell, such as e.g. for the wireless communications network 100 in the cell 10 provided by the second network node 112. FIG. 8 illustrates that from a statistical analysis of downlink throughput it is possible to derive the performance parameter such as a TTC. To the left is a Cumulative Distribution Function (CDF) of observed bitrates of the UE connections. From this it can be derived that the 80th percentile of the downlink UE throughput is 13 Mbps. With this bitrate it should take approximately 1.2 seconds to download a 2 MB file. In the left figure live measurements of the TTC for the same time period is illustrated and it is noted that the estimation of 1.2 seconds TTC is in good agreement with the measurements. The TTC measurement were done in one or more UEs 120 out of the UEs 120 and it is difficult to directly measure the TTC in the wireless communications network 100 such as the cell 10. But a very close agreement between the estimated TTC and the TTC observed by the UE 120 indicates that it is not needed to measure TTC directly in the wireless communications network 100 such as in the cell provided by second network node 112. The TTC that the one or more UE 120 experience may be derived from UE throughput measurements that the wireless communications network 100 such the second network node 112 can observe directly. In this example it is known that since the 80th percentile DL user throughput is 13 Mbps, that implies that 80% of the TTC is 1.2 seconds, i.e. the time it takes to download 2 MB with a bit rate of 13 Mbps.

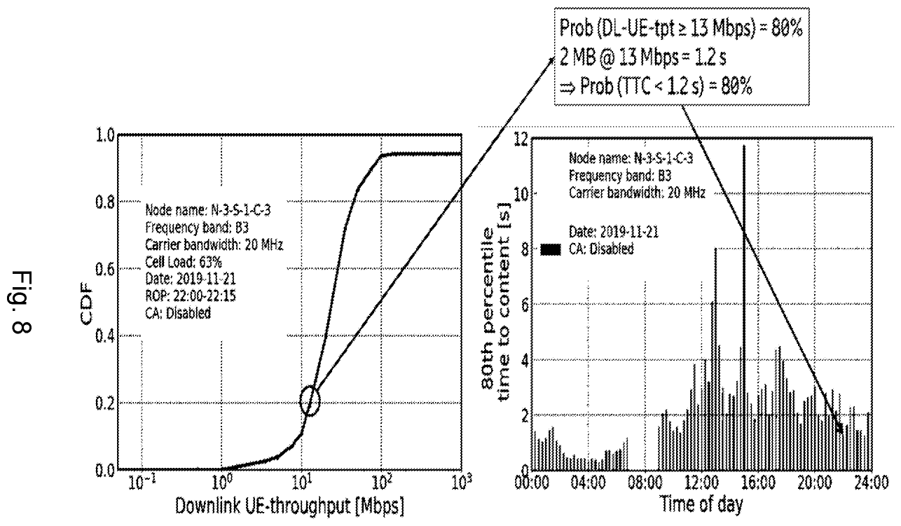

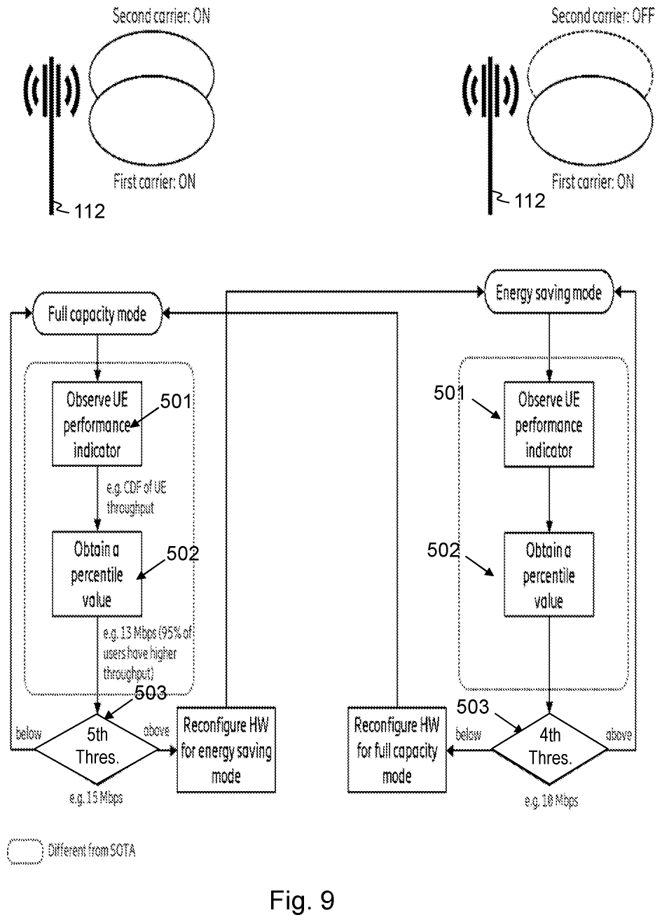

Knowing the TTC for a content of a UE connection, e.g. an MBB content, enables a much more precise triggering of energy saving features compared to what is possible in state-of-the-art (SOTA). An example embodiment of the first network node 111 utilizing this for the second network node 112 is depicted in FIG. 9. Note that the Action reference numbers 501-503 used above are also used here for the similar corresponding actions. By first obtaining 501 one or more performance parameters related to data traffic performance of UE connections served by the second network node 112 during a time interval, and determining 502 a proportion of the UE connections that are associated with a performance parameter exceeding a first threshold, based on the obtained one or more performance parameters, a high percentile value of the downlink user throughput, such as e.g. 80%, it may be decided 503 if the current TTC value of the UE experience in the UE connections is good or not, i.e. exceeds the first threshold. If the estimated TTC value is unnecessary low, it may be decided to choose to trigger an energy saving operational mode. If the second network node 112 is currently operating in a first power consumption level that is an energy saving mode, the distribution of UE connection throughput observations may be monitored during the time period to obtain the performance parameters, i.e. UE connection throughput related to data traffic performance of UE connections served by the second network node 112 during a time interval, and to to determine based on this, when it is time to switch to the second power consumption level, as in this example is back to a full capacity mode.

In the rightmost loop of FIG. 9, the starting point of the method is where the second network node use the first power consumption level as being a low power consumption level, referred to as the energy saving mode.

In one example scenario in the rightmost loop of FIG. 9, the first network node 111 decides 503 to switch from the low power consumption level to the high power consumption level referred to as the full capacity mode, when the determined proportion of UE connections that are associated with a performance parameter exceeding the first threshold, is exceeding a fourth threshold. In this example exceeding a fourth threshold means being below the fourth threshold value. This may be performed by reconfigure hardware (HW) in the second network node 112 for full capacity mode.

In the leftmost loop of FIG. 9, the starting point of the method is where the second network node use the first power consumption level as being a high power consumption level, referred to as the full capacity mode.

In an example scenario in the leftmost loop of FIG. 9, the first network node 111 decides 503 to switch from the high power consumption level to the low power consumption level referred to as the energy saving mode, when the determined proportion of UE connections that are associated with a performance parameter exceeding the first threshold, is exceeding a fifth threshold. In this example exceeding a fifth threshold means being above the fifth threshold value. This may be performed by reconfigure HW in the second network node 112 for energy saving mode mode.

An example of embodiments of the method in the first network node 111 may comprise:

A method for reducing energy consumption characterized by:
Observing UE experience such as user-experience related performance indicators, also referred to as parameters, of several UE data transmissions, also referred to as UE connections, in a time interval,
Determining a proportion of the UE connections that are associated with a performance parameter exceeding a first threshold, based on the obtained one or more performance parameters, such as e.g. by obtaining a percentile value of the user data throughput based on said observations,
deciding whether or not to switch from the first power consumption level to a second power consumption level out of the multiple power consumption levels based on the determined proportion of UE connections that are associated with a performance parameter exceeding the first threshold, by:
Configuring the second network node 112 for a low power consumption mode if said percentile value is above a first threshold, and
Configuring the second network node 112 for a high capacity mode if said percentile value is above a second threshold

Wherein, in some embodiments, it is possible to
Predict future data throughput of UE transmissions
Determining which hardware component to de-activate (e.g. should the cell do MIMO sleep or go into Cell-sleep) in dependence of expected energy saving, expected impact on data throughput of user transmissions, expected re-activation time, or expected future traffic.
When entering said low power consumption mode, at least one hardware component is deactivated.
When entering said high capacity mode, at least one hardware component is reactivated.

Wherein, in some embodiments,
Said throughput observations relate to downlink user data and said deactivation relate to at least one component used for data transmission.
Said throughput observations relate to uplink user data and said deactivation relate to at least one component used for data reception.
There may be several low energy consumption modes associated with different energy consumption, activation delay, and capacity.

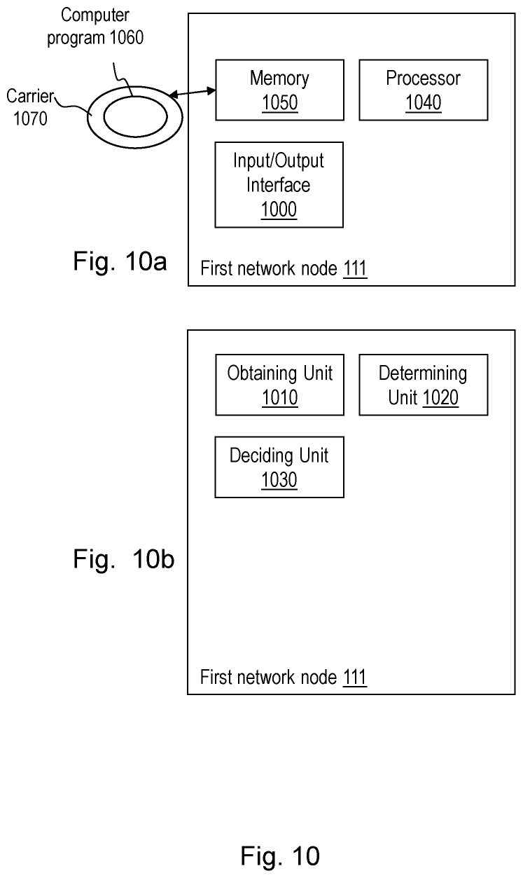

To perform the method actions above, the first network node may comprise an arrangement depicted in FIGS. 10a and 10 b. The first network node 111 is configured to control power consumption in a second network node 112 in a wireless communications network 100. The second network node 112 is adapted to operate in a first power consumption level out of multiple power consumption levels.

The first network node 111 and the second network node 112 may be adapted to be co-located.

The first network node 111 may comprise an input and output interface 1000 configured to communicate with network nodes such as the second network node 112 and UEs such as the UE 120. The input and output interface may comprise a wireless receiver (not shown) and a wireless transmitter (not shown).

The first network node 111 is further configured to, e.g. by means of an obtaining unit 1010, obtain one or more performance parameters adapted to be related to data traffic performance of UE connections served by the second network node 112 during a time interval.

The one or more performance parameters may be adapted to be aggregated in any one or more out of: A cell, a frequency band, sector of a cell, a network node site, a cluster of network node sites, a region, a geographical area.

The one or more performance parameters may be adapted to be obtained by estimating the one or more performance parameters.

The one or more performance parameters may be adapted to be obtained by receiving the one or more performance parameters from any one out of: The second network node 112, another network node operating in the wireless communications network 100, a function operating in the wireless communications network 100, or UEs 120 in the UE connections.

The first network node 111 is further configured to, e.g. by means of a determining unit 1020, determine a proportion of the UE connections that are adapted to be associated with a performance parameter exceeding a first threshold. The determination is based on the obtained one or more performance parameters.

The first network node 111 is further configured to, e.g. by means of a deciding unit 1030, decide whether or not to switch from the first power consumption level to a second power consumption level out of the multiple power consumption levels. The decision is based on the determined proportion of UE connections that are associated with a performance parameter exceeding the first threshold.

The multiple power consumption levels may be adapted to comprise at least: a low power consumption level wherein the second network node 112 is adapted to consume power below a second threshold, and a high power consumption level wherein the second network node 112 is adapted to consume power above a third threshold.

The first power consumption level may be adapted to be represented by the low power consumption level.

The first network node 111 may further be configured to e.g. by means of the deciding unit 1030, decide whether or not to switch by deciding to switch from the low power consumption level to the high power consumption level, when the determined proportion of UE connections that are adapted to be associated with a performance parameter exceeding the first threshold, is exceeding a fourth threshold.

The first power consumption level may be represented by the high power consumption level.

The first network node 111 may further be configured to e.g. by means of the deciding unit 1030, decide whether or not to switch by deciding to switch from the high power consumption level to the low power consumption level, when the determined proportion of UE connections that are adapted to be associated with a performance parameter exceeding the first threshold, is exceeding a fifth threshold.

The low power consumption level may be adapted to comprise to activate in the second network node 112, any one out of: a cell-sleep, a MIMO sleep, a Massive MIMO sleep, or a booster carrier sleep.

The second power consumption level of the multiple power consumption levels may be adapted to comprise zero power consumption.

The first, fourth, and/or fifth thresholds may be adapted to depend on any one out of: The time of day, or the region of the UE connections.

The embodiments herein may be implemented through a respective processor or one or more processors, such as the processor 1040 of a processing circuitry in the first network node 111 depicted in FIG. 10a, together with respective computer program code for performing the functions and actions of the embodiments herein. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 1050 comprising one or more memory units. The memory 1050 comprises instructions executable by the processor 1040 in the first network node 111. The memory 1050 is arranged to be used to store e.g. performance parameters, power consumption levels, thresholds, UE connections, decisions, data, communication data and applications to perform the methods herein when being executed in the first network node 111.

In some embodiments, a computer program 1060 comprises instructions, which when executed by the respective at least one processor 740, cause the at least one processor 740 of the first network node 111 to perform the actions above.

In some embodiments, a respective carrier 1070 comprises the respective computer program 1060, wherein the carrier 1070 is one of an electronic signal, an optical signal, an electromagnetic signal, a magnetic signal, an electric signal, a radio signal, a microwave signal, or a computer-readable storage medium.

Those skilled in the art will appreciate that the units in the first network node 111 described above may refer to a combination of analog and digital circuits, and/or one or more processors configured with software and/or firmware, e.g. stored in the first network node 111, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

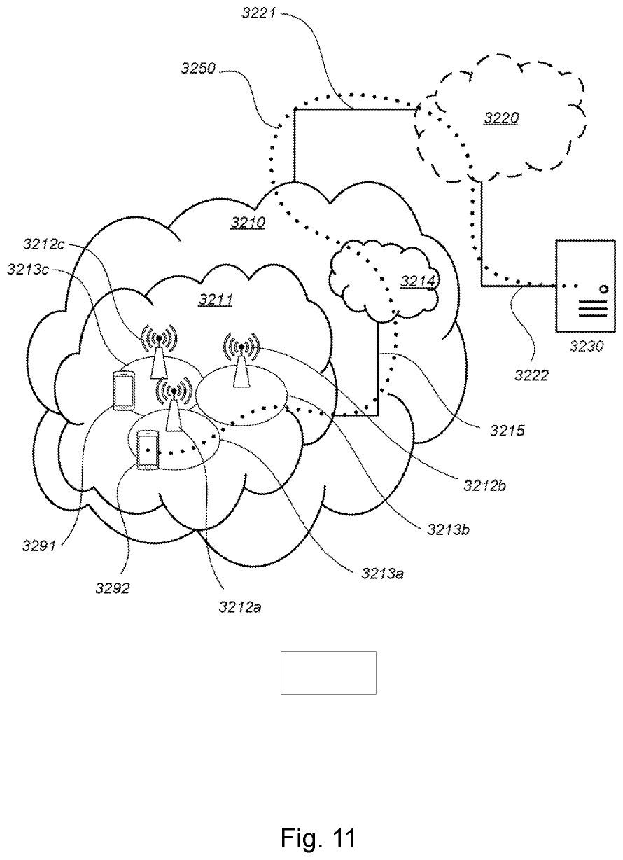

With reference to FIG. 11, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the first network node 111 and the second network node 112, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as the UE 120 and/or a Non-AP STA 3291 located in coverage area 3213c is configured to wirelessly connect to, or be paged by, the corresponding base station 3212c. A second UE 3292 such as the second UE 122 and/or a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 11 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

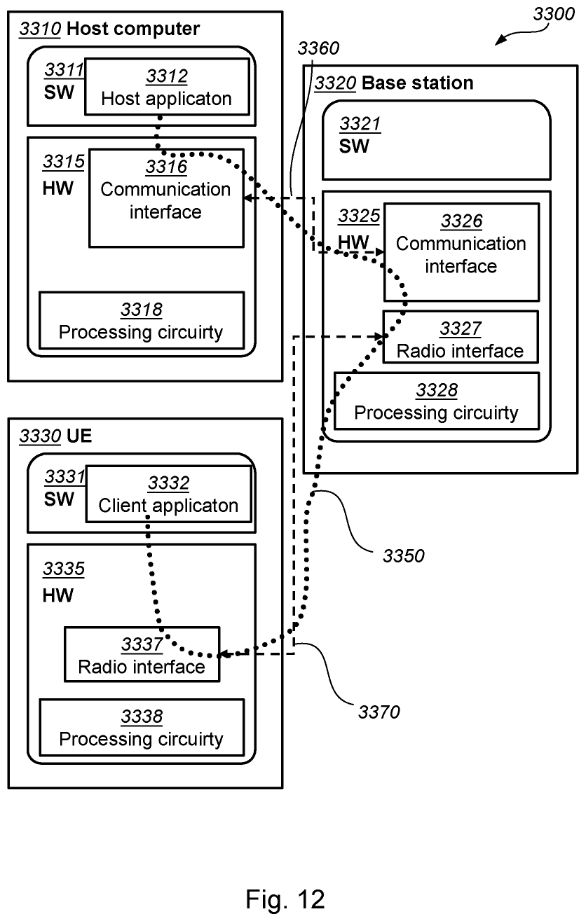

Example implementations, in accordance with an embodiment, of the UE, base station and host computer discussed in the preceding paragraphs will now be described with reference to FIG. 12. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 12) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 11, respectively. This is to say, the inner workings of these entities may be as shown in FIG. 11 and independently, the surrounding network topology may be that of FIG. 11.

In FIG. 11, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the [select the applicable RAN effect: data rate, latency, power consumption] and thereby provide benefits such as [select the applicable corresponding effect on the OTT service: reduced user waiting time, relaxed restriction on file size, better responsiveness, extended battery lifetime].

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

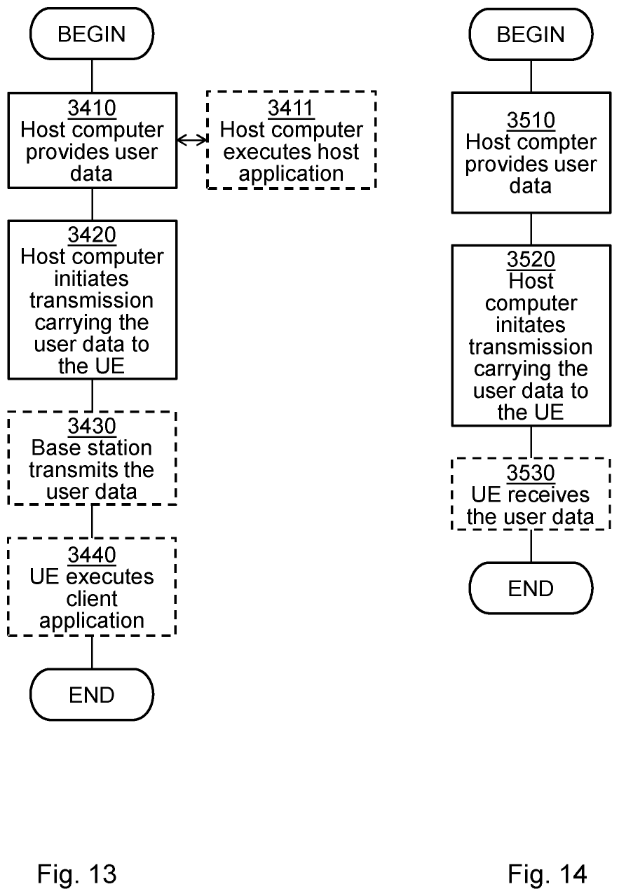

FIG. 13 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 13 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 14 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

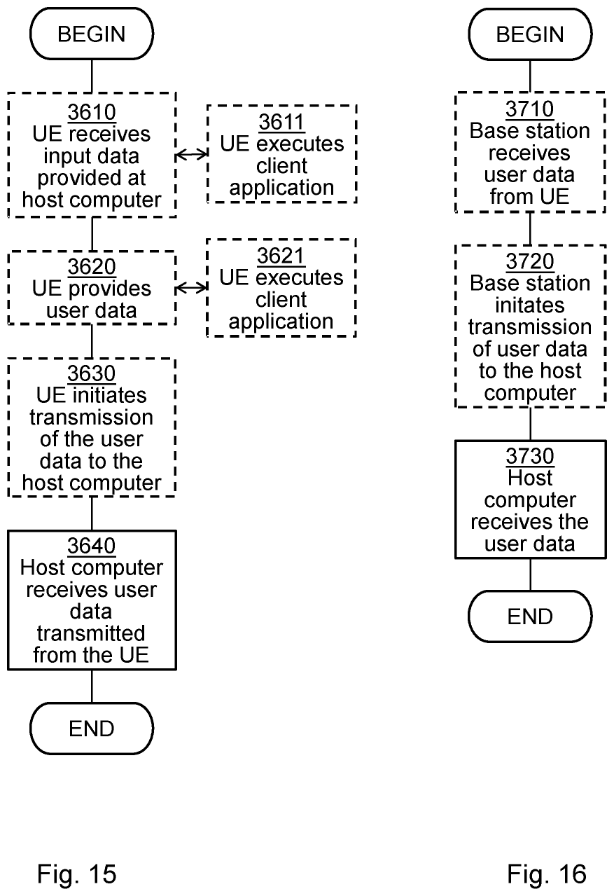

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 15 will be included in this section. In an optional first step 3610 of the method, the UE receives input data provided by the host computer. Additionally, or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 12. For simplicity of the present disclosure, only drawing references to FIG. 16 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a first network node for controlling power consumption in a second network node in a wireless communications network, wherein the second network node is operating in a first power consumption level out of multiple power consumption levels, the method comprising:
obtaining one or more performance parameters related to data traffic performance of User Equipment, UE, connections served by the second network node during a time interval,
determining a proportion of the UE connections that are associated with a performance parameter exceeding a first threshold, based on the obtained one or more performance parameters,
deciding whether or not to switch from the first power consumption level to a second power consumption level out of the multiple power consumption levels based on the determined proportion of UE connections that are associated with a performance parameter exceeding the first threshold.

2. The method according to claim 1, wherein
the multiple power consumption levels comprises at least:
a low power consumption level wherein the second network node consumes power below a second threshold, and
a high power consumption level wherein the second network node consumes power above a third threshold,
the first power consumption level is represented by the low power consumption level, and
the deciding of whether or not to switch comprises deciding to switch from the low power consumption level to the high power consumption level, when the determined proportion of UE connections that are associated with a performance parameter exceeding the first threshold, is exceeding a fourth threshold.

3. The method according to claim 1, wherein
the multiple power consumption levels comprises at least:
a low power consumption level wherein the second network node consumes power below a second threshold, and
a high power consumption level wherein the second network node consumes power above a third threshold,
the first power consumption level is represented by the high power consumption level, and
the deciding of whether or not to switch comprises deciding to switch from the high power consumption level to the low power consumption level, when the determined proportion of UE connections that are associated with a performance parameter exceeding the first threshold, is exceeding a fifth threshold.

4. The method according to claim 3, wherein the low power consumption level comprises to activate in the second network node, any one out of: a cell-sleep, a MIMO sleep, a Massive MIMO sleep, or a booster carrier sleep.

5. The method according to claim 1, wherein the second power consumption level of the multiple power consumption levels comprises zero power consumption.

6. The method according to claim 1, wherein the one or more performance parameters are aggregated in any one or more out of:
a cell, a frequency band, sector of a cell, a network node site, a cluster of network node sites, a region, a geographical area.

7. The method according to claim 1, wherein the one or more performance parameters are obtained by estimating the one or more performance parameters.

8. The method according to claim 1, wherein the one or more performance parameters are obtained by receiving the one or more performance parameters from any one out of:
the second network node,
another network node operating in the wireless communications network,
a function operating in the wireless communications network, or
UEs in the UE connections.

9. The method according to claim 1, wherein the first, fourth, or fifth thresholds depend on any one out of:
the time of day, or
the region of the UE connections.

10. The method according to claim 1, wherein the first network node and the second network node are co-located.

11. A computer program comprising instructions, which when executed by a processor, causes the processor to perform actions according to claim 1.

12. A carrier comprising the computer program of claim 11, wherein the carrier is one of an electronic signal, an optical signal, an electromagnetic signal, a magnetic signal, an electric signal, a radio signal, a microwave signal, or a computer-readable storage medium.

13. A first network node configured to control power consumption in a second network node in a wireless communications network, wherein the second network node is adapted to operate in a first power consumption level out of multiple power consumption levels, wherein the first network node further is configured to:
obtain one or more performance parameters adapted to be related to data traffic performance of User Equipment, UE, connections served by the second network node during a time interval,
determine a proportion of the UE connections that are adapted to be associated with a performance parameter exceeding a first thresholdbased on the obtained one or more performance parameters,
decide whether or not to switch from the first power consumption level to a second power consumption level out of the multiple power consumption levels based on the determined proportion of UE connections that are associated with a performance parameter exceeding the first threshold.

14. The first network node according to claim 13, wherein
the multiple power consumption levels are adapted to comprise at least:
a low power consumption level wherein the second network node is adapted to consume power below a second threshold, and
a high power consumption level wherein the second network node is adapted to consume power above a third threshold,
the first power consumption level is adapted to be represented by the low power consumption level, and
the first network node further is configured to decide whether or not to switch by deciding to switch from the low power consumption level to the high power consumption level, when the determined proportion of UE connections that are adapted to be associated with a performance parameter exceeding the first threshold, is exceeding a fourth threshold.

15. The first network node according to claim 13, wherein
the multiple power consumption levels are adapted to comprise at least:
a low power consumption level wherein the second network node consumes power below a second threshold, and
a high power consumption level wherein the second network node consumes power above a third threshold,
the first power consumption level is represented by the high power consumption level, and
the first network node further is configured to decide whether or not to switch by deciding to switch from the high power consumption level to the low power consumption level, when the determined proportion of UE connections that are adapted to be associated with a performance parameter exceeding the first threshold, is exceeding a fifth threshold.

16. The first network node according to claim 15, wherein the low power consumption level is adapted to comprise to activate in the second network node, any one out of: a cell-sleep, a MIMO sleep, a Massive MIMO sleep, or a booster carrier sleep.

17. The first network node according to claim 13, wherein the second power consumption level of the multiple power consumption levels is adapted to comprise zero power consumption.

18. The first network node according to claim 13, wherein the one or more performance parameters are adapted to be aggregated in any one or more out of:
a cell, a frequency band, sector of a cell, a network node site, a cluster of network node sites, a region, a geographical area.

19. The first network node according to claim 13, wherein the one or more performance parameters are adapted to be obtained by estimating the one or more performance parameters.

20. The first network node according to claim 13 wherein the one or more performance parameters are adapted to be obtained by receiving the one or more performance parameters from any one out of:
the second network node,
another network node operating in the wireless communications network,
a function operating in the wireless communications network, or
UEs in the UE connections.

21. The first network node according to claim 13, wherein the first, fourth, or fifth thresholds are adapted to depend on any one out of:
the time of day, or
the region of the UE connections.

22. The first network node according to claim 13, wherein the first network node and the second network node are adapted to be co-located.
